(19) United States
(12) Patent Application Publication
(10) Pub. No.: US 2026/0208354 A1
(43) Pub. Date: Jul. 23, 2026

(54) SYSTEM AND METHOD FOR SAMPLE-EFFICIENT SEQUENTIAL COMPARATIVE EVALUATION OF ROBOT POLICIES

(71) Applicant: TOYOTA RESEARCH INSTITUTE, INC., Los Altos, CA (US)

(72) Inventors: David A. SNYDER, Princeton, NJ (US); Haruki NISHIMURA, Sunnyvale, CA (US); Mikhal ITKINA, Palo Alto, CA (US); Rares Andrei AMBRUS, San Francisco, CA (US)

(73) Assignees: TOYOTA RESEARCH INSTITUTE, INC., Los Altos, CA (US); TOYOTA JIDOSHA KABUSHIKI KAISHA, Aichi-Ken (JP)

(21) Appl. No.: 19/313,534

(22) Filed: Aug. 28, 2025

Related U.S. Application Data
(60) Provisional application No. 63/748,853, filed on Jan. 23, 2025.
(60) Provisional application No. 63/794,545, filed on Apr. 25, 2025.

(51) Int. Cl. B25J 9/16

(52) U.S. Cl. CPC B25J 9/163; G05B 2219/33002; G05B 2219/39001

(57) ABSTRACT

A method for a robot control policy evaluation framework is described. The method includes selecting a first robot control policy and a second robot control policy from a plurality of robot control policies. The method also includes performing a sequential testing of the first robot control policy and the second robot control policy. The method further includes incrementally collecting statistical evidence during the performing of the sequential testing. The method also includes completing the sequential testing in response to the statistical evidence establishing a performance of the first robot control policy being greater than the performance of the second robot control policy or the performance of the second robot control policy being less than the performance of the first robot control policy.

### CROSS-REFERENCE TO RELATED APPLICATION

The present application claims the benefit of U.S. Provisional Patent Application No. 63/794,545, filed Apr. 25, 2025, and titled “POLICY COMPARISON WITH NEAR-OPTIMAL STOPPING,” and U.S. Provisional Patent Application No. 63/748,853, filed Jan. 23, 2025, and titled “POLICY COMPARISON WITH NEAR-OPTIMAL STOPPING,” the disclosure of which are expressly incorporated by reference in their entirety.

### BACKGROUND

### Field

Certain aspects of the present disclosure relate to robotics and, more particularly, sample-efficient sequential comparative evaluation of robot policies.

### Background

Imitation learning enables robots to perform complex, long-horizon tasks in challenging dexterous manipulation settings. Trustworthy and efficient robot policy evaluation protocols are paramount in imitation learning as the scale of underlying deep learning models and the complexity of tasks continue to increase. This is especially pronounced in dexterous manipulation where stochastic, contact-rich interactions between the robot and the environment introduce inherent randomness in outcomes. New imitation learning methods are rigorously evaluated and compared against corresponding baselines through repeated evaluation trials to ensure an efficient and trustworthy robot policy. Unfortunately, policy comparison is constrained by a small sample size due to significant human effort and limited policy inference throughput.

Existing policy evaluation methods are generally limited to batch methods that involve a fixed number N of policy trials prior to running an experiment. This rigidity is undesirable in the following two scenarios that are often encountered in policy evaluation. First, when the true success rate of Policy A is significantly higher than that of Policy B, much fewer trials than N may suffice to establish that A>B with statistical assurances. Nonetheless, all N trials are conducted for each policy before the roboticist can perform the statistical analysis, leading to wasted time and hardware resources. In the second scenario, where Policy A and Policy B are closely matched, N trials may not provide sufficient statistical power to determine whether A>B or A<B with confidence. In such a case, the roboticist has to re-do the same experiment with the same or an increased N. Even worse, they have to discard the previously obtained evaluation results, as reusing them would compromise statistical validity.

### SUMMARY

A method for a robot control policy evaluation framework is described. The method includes selecting a first robot control policy and a second robot control policy from a plurality of robot control policies. The method also includes performing a sequential testing of the first robot control policy and the second robot control policy. The method further includes incrementally collecting statistical evidence during the performing of the sequential testing. The method also includes completing the sequential testing in response to the statistical evidence establishing a performance of the first robot control policy being greater than the performance of the second robot control policy or the performance of the second robot control policy being less than the performance of the first robot control policy.

A non-transitory computer-readable medium having program code recorded thereon for a robot control policy evaluation framework is described. The program code is executed by a processor. The non-transitory computer-readable medium includes program code to select a first robot control policy and a second robot control policy from a plurality of robot control policies. The non-transitory computer-readable medium also includes program code to perform a sequential testing of the first robot control policy and the second robot control policy. The non-transitory computer-readable medium further includes program code to incrementally collect statistical evidence during the performing of the sequential testing. The non-transitory computer-readable medium also includes program code to complete the sequential testing in response to the statistical evidence establishing a performance of the first robot control policy being greater than the performance of the second robot control policy or the performance of the second robot control policy being less than the performance of the first robot control policy.

A system for a robot control policy evaluation framework is described. The system includes a robot and a control policy evaluation server. The control policy evaluation server includes a control policy selection module to select a first robot control policy and a second robot control policy from a plurality of robot control policies to control the robot. The control policy evaluation server also includes a sequential testing module to perform a sequential testing of the first robot control policy and the second robot control policy. The control policy evaluation server further includes a statistical data selection to incrementally collect statistical evidence during the performing of the sequential testing. The control policy evaluation server includes a control policy evaluation module to complete the sequential testing in response to the statistical evidence establishing a performance of the first robot control policy being greater than the performance of the second robot control policy or the performance of the second robot control policy being less than the performance of the first robot control policy.

This has outlined, broadly, the features and technical advantages of the present disclosure in order that the detailed description that follows may be better understood. Additional features and advantages of the present disclosure will be described below. It should be appreciated by those skilled in the art that the present disclosure may be readily utilized as a basis for modifying or designing other structures for conducting the same purposes of the present disclosure. It should also be realized by those skilled in the art that such equivalent constructions do not depart from the teachings of the present disclosure as set forth in the appended claims. The novel features, which are believed to be characteristic of the present disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of a system and method for a sequential statistical testing method to evaluate robot control policies using a system-on-a-chip (SOC) of a robot, in accordance with aspects of the present disclosure.

FIG. 2 is a block diagram illustrating a software architecture for sequential statistical testing method to evaluate robot control policies from imitation learning using, according to aspects of the present disclosure.

FIG. 3 is a diagram illustrating an example of a hardware implementation for a control policy evaluation system for robotic imitation learning of the robot control policy, according to various aspects of the present disclosure.

FIG. 4 is a diagram illustrating trial-based robotic control policy evaluation, according to various aspects of the present disclosure.

FIG. 5 illustrates a policy performance comparison graph for robotic control policy evaluation, according to various aspects of the present disclosure.

FIGS. 6A-6C further illustrates policy performance comparison graph of FIG. 5, according to various aspects of the present disclosure.

FIG. 7 is a flowchart illustrating a method 700 for an imitation learning robot control policy evaluation framework, according to aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. It will be apparent to those skilled in the art, however, that these concepts may be practiced without these specific details. In some instances, well-known structures and components are shown in block diagram form to avoid obscuring such concepts.

Based on the teachings, one skilled in the art should appreciate that the scope of the present disclosure is intended to cover any aspect of the present disclosure, whether implemented independently of or combined with any other aspect of the present disclosure. For example, an apparatus may be implemented, or a method may be practiced using any number of the aspects set forth. In addition, the scope of the present disclosure is intended to cover such an apparatus or method practiced using other structure, functionality, or structure and functionality in addition to, or other than the various aspects of the present disclosure set forth. Any aspect of the present disclosure disclosed may be embodied by one or more elements of a claim.

Although aspects are described herein, many variations and permutations of these aspects fall within the scope of the present disclosure. Although some benefits and advantages of the preferred aspects are mentioned, the scope of the present disclosure is not intended to be limited to benefits, uses, or objectives. Rather, aspects of the present disclosure are intended to be universally applicable to different technologies, system configurations, networks, and protocols, some of which are illustrated by way of example in the figures and in the following description of the preferred aspects. The detailed description and drawings are merely illustrative of the present disclosure, rather than limiting the scope of the present disclosure being defined by the appended claims and equivalents thereof.

Imitation learning enables robots to perform complex, long-horizon tasks in challenging dexterous manipulation settings. Trustworthy and efficient robot policy evaluation protocols are paramount in imitation learning as the scale of underlying deep learning models and the complexity of tasks continue to increase. This is especially pronounced in dexterous manipulation where stochastic, contact-rich interactions between the robot and the environment introduce inherent randomness in outcomes. New imitation learning methods are rigorously evaluated and compared against corresponding baselines through repeated evaluation trials to ensure an efficient and trustworthy robot policy. Unfortunately, policy comparison is constrained by a small sample size due to significant human effort and limited policy inference throughput.

Prior work in statistical policy comparison relies on batch testing, which requires a fixed, pre-determined number of trials and lacks flexibility in adapting the sample size to the observed evaluation data. Furthermore, extending the test with additional trials risks inducing inadvertent p-hacking, which undermines statistical assurances. In particular, existing policy evaluation methods are generally limited to batch methods that involve a fixed number N of policy trials prior to running an experiment. This rigidity is undesirable in the following two scenarios that are often encountered in policy evaluation.

According to a first scenario encountered in policy evaluation, when the true success rate of Policy A is significantly higher than that of Policy B, much fewer trials than N may suffice to establish that A>B. Nonetheless, all N trials are conducted for each policy before the roboticist can perform the statistical analysis, leading to wasted time and hardware resources. In a second scenario encountered in policy evaluation, where Policy A and Policy B are closely matched, N trials may not provide sufficient statistical power to determine whether A>B or A<B. In such a case, the roboticist has to re-do the same experiment with the same or an increased N. Even worse, they have to discard the previously obtained evaluation results, as reusing them would compromise statistical validity. A novel statistical framework for rigorously comparing two policies utilizing a small sample size regime is desired.

Various aspects of the present disclosure are directed to sequential statistical testing, which allow researchers to decide whether or not to run more trials based on intermediate results. This sequential statistical testing adaptively tailors the number of trials to the difficulty of the underlying comparison, saving significant time and effort without sacrificing probabilistic correctness. Extensive numerical simulation and real-world robot manipulation experiments demonstrate that the disclosed sequential statistical testing achieves near-optimal stopping, enabling researchers to stop evaluation and decide on a policy in a near-minimal number of trials.

In particular, the disclosed sequential statistical testing may significantly reduce the number of evaluation trials (e.g., by up to 32%) relative to state-of-the-art baselines, while preserving the probabilistic correctness and statistical power of the policy comparison. A sequential statistical testing method is strongest in the most challenging comparison instances (e.g., comparison instances requiring the largest possible amount of evaluation trials). Beneficially, in a multi-task comparison scenario, this sequential statistical testing method saves the evaluator a significant number (e.g., more than 160) simulation rollouts. Although described with reference to imitation learning, the sequential testing for efficient policy comparison or STEP is naturally applicable to evaluating any types of policies based on binary metrics, including reinforcement learning (RL) policies with sparse 0/1 reward.

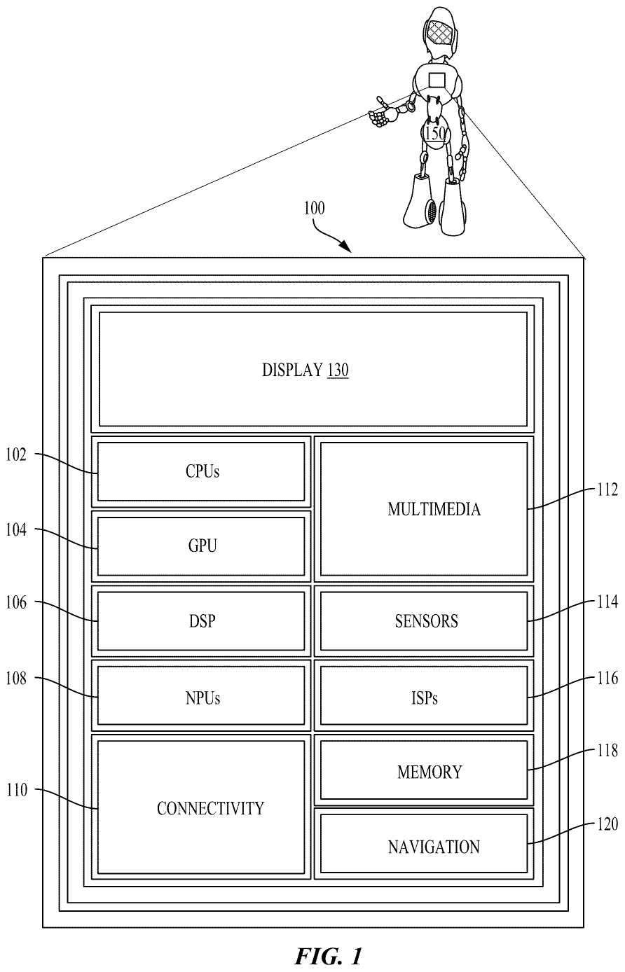

FIG. 1 illustrates an example implementation of a system and method for sequential statistical testing method using a system-on-a-chip (SOC) 100 to evaluate policies for a robot 150, in accordance with aspects of the present disclosure. The SOC 100 may include a single processor or multi-core processors (e.g., a central processing unit), in accordance with certain aspects of the present disclosure. Variables (e.g., neural signals and synaptic weights), system parameters associated with a computational device (e.g., neural network with weights), delays, frequency bin information, and task information may be stored in a memory block. The memory block may be associated with a neural processing unit (NPU) 108, a CPU 102, a graphics processing unit (GPU) 104, a digital signal processor (DSP) 106, a dedicated memory block 118, or may be distributed across multiple blocks. Instructions executed at a processor (e.g., CPU 102) may be loaded from a program memory associated with the CPU 102 or may be loaded from the dedicated memory block 118.

The SOC 100 may also include additional processing blocks configured to perform specific functions, such as the GPU 104, the DSP 106, and a connectivity block 110, which may include sixth generation (6G) connectivity, sixth generation (6G) new radio (NR) connectivity, fourth generation long term evolution (4G LTE) connectivity, unlicensed Wi-Fi connectivity, USB connectivity, Bluetooth® connectivity, and the like. In addition, a multimedia processor 112 in combination with a display 130 may, for example, classify and categorize poses of a humanoid robot, according to the display 130 (e.g., an augmented reality (AR) head mounted display (HMD) illustrating a view of the robot 150. In some aspects, the NPU 108 may be implemented in the CPU 102, DSP 106, and/or GPU 104. The SOC 100 may further include a sensor processor 114, image signal processors (ISPs) 116, and/or navigation 120, which may, for instance, include a global positioning system.

The SOC 100 may be based on an Advanced Risc Machine (ARM) instruction set, RISC-V, or any reduced instruction set computing (RISC) architecture, or the like. In another aspect of the present disclosure, the SOC 100 may be a server computer in communication with the robot 150. In this arrangement, the robot 150 may include a processor and other features of the SOC 100. In this aspect of the present disclosure, instructions loaded into a processor (e.g., the CPU 102) or the NPU 108 of the robot 150 may include code for a control policy evaluation framework (e.g., of the robot 150) to enable imitation learning by the robot 150 of robot control policy from images captured by the sensor processor 114 of the robot 150.

The instructions loaded into a processor (e.g., the CPU 102) may also include code to select a first imitation learning robot control policy and a second imitation learning robot control policy from a plurality of imitation learning robot control policies. The instructions loaded into a processor (e.g., the CPU 102) may further include code to perform sequential testing of the first imitation learning robot control policy and the second imitation learning robot control policy. The instructions loaded into a processor (e.g., the CPU 102) may also include code to incrementally collect statistical evidence during the performing of the sequential testing. The instructions loaded into a processor (e.g., the CPU 102) may further include code to complete the sequential testing in response to the statistical evidence establishing a performance of the first imitation learning robot control policy being greater than a performance of the second imitation learning robot control policy or the performance of the second imitation learning robot control policy being less than the performance of the first imitation learning robot control policy, such as hardware-based control policies or software-based control policies.

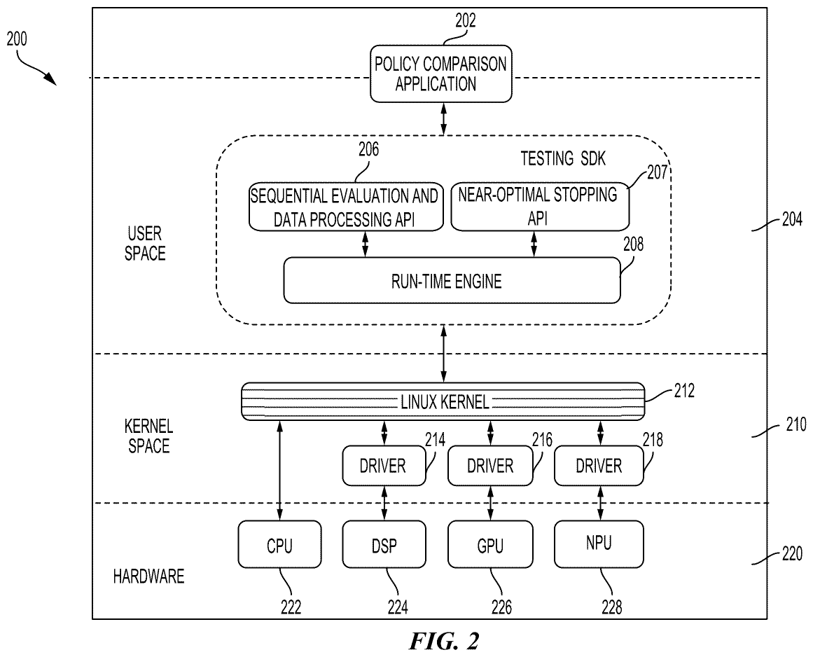

FIG. 2 is a block diagram illustrating a software architecture 200 for a control policy evaluation framework for robotic imitation learning of a robot control policy, according to aspects of the present disclosure. Using the software architecture 200, a policy comparison application 202 may be designed such that it may cause various processing blocks of a system-on-a-chip (SOC) 220 (for example a CPU 222, a DSP 224, a GPU 226, and/or an NPU 228) to perform supporting computations during run-time operation of the policy comparison application 202.

The policy comparison application 202 may be configured to call functions defined in a user space 204 that may, for example, provide a control policy evaluation framework for robotic imitation learning of robot control policy, according to aspects of the present disclosure. In various aspects of the present disclosure, the policy comparison application 202 may make a request to compile program code associated with a library defined in a sequential testing and statistical data application programming interface (API) 206 to select a first imitation learning robot control policy and a second imitation learning robot control policy from a plurality of imitation learning robot control policies. The sequential testing and statistical data API 206 may perform sequential testing of the first imitation learning robot control policy and the second imitation learning robot control policy. The sequential testing and statistical data API 206 may also incrementally collect statistical evidence during the performing of the sequential testing.

A near-optimal stopping API 207 may complete the sequential testing in response to the statistical evidence establishing a performance of the first imitation learning robot control policy being greater than a performance of the second imitation learning robot control policy or the performance of the second imitation learning robot control policy being less than the performance of the first imitation learning robot control policy. Additionally, the near-optimal stopping API 207 may stop the sequential testing, allowing researchers to decide whether or not to run more trials based on intermediate results. According to various aspects of the present disclosure, the first imitation learning robot control policy and the second imitation learning robot control policy may be composed of hardware-based robot control policies or software-based robot control policies.

A run-time engine 208, which may be compiled code of a run-time framework, may be further accessible to the policy comparison application 202. The policy comparison application 202 may cause the run-time engine 208, for example, to perform policy comparison of robotic control policies. When an intermediate test comparison results of an intermediate step are available, the run-time engine 208 may in turn send a signal to an operating system 210, such as a Linux Kernel 212, running on the SOC 220. The operating system 210, in turn, may cause a computation to be performed on the CPU 222, the DSP 224, the GPU 226, the NPU 228, or some combination thereof. The CPU 222 may be accessed directly by the operating system 210, and other processing blocks may be accessed through a driver, such as drivers 214-218 for the DSP 224, for the GPU 226, or for the NPU 228. In the illustrated example, the deep neural network may be configured to run on a combination of processing blocks, such as the CPU 222 and the GPU 226, or may be run on the NPU 228 if present.

Comparing the performance of two imitation learning robot policies, Policy A and Policy B, in a statistically reliable manner presents a significant challenge. For example, these policies may have completely different architectures and algorithms, or they may share the same architecture but differ in the values of their neural network weights. Regardless, hardware evaluation is necessary to assess performance for several reasons. First, imitation learning policies are often complex black box machine learning models that are difficult to analyze deductively. Second, although it is possible to replicate tasks in a simulated environment and run experiments there, simulators are inherently limited by a simulation-to-real gap and cannot fully replace hardware evaluation, especially for highly dexterous tasks that may involve non-rigid objects.

In hardware evaluation, a common practice is to execute both Policy A and Policy B on several pre-designed tasks, with each policy performed as few as 10-20 times on each task to measure its “success rate.” This success rate is typically calculated as the fraction of times the policy successfully completes the task according to user-specified success criteria. Then, Policy A is deemed more performant than Policy B on a task if its empirical success rate is higher; however, this naive interpretation fails to account for random variability as a potential source of error.

In particular, an “empirical success rate” is simply a realization of a random variable distributed according to a Bernoulli distribution, and thus it cannot be equated with the “true success rate”—the underlying Bernoulli parameter that we want to know but cannot observe directly. Although the empirical success rate is an unbiased estimator for the true success rate, its variance introduces a practical risk of misinterpreting the results. This variance issue is predominant in hardware evaluation where only 10-20 trials are possible due to its time-consuming nature. For instance, it is possible to conclude that Policy A is more performant than Policy B when, in fact, the opposite is true, and randomness happened to favor Policy A in a set of 10 trials. Such an unreliable interpretation can easily lead to a reproducibility crisis and should be mitigated.

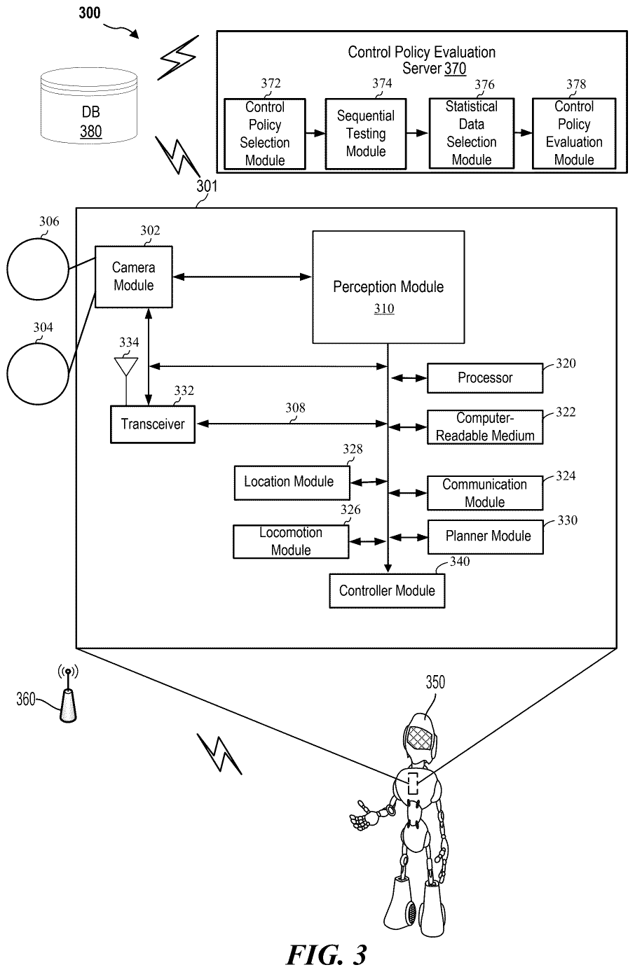

For example, existing policy evaluation methods, such as one described by (Vincent et al., 2024) and the Barnard's test (Barnard, 1945), are batch methods that require the number of policy trials N to be fixed prior to running an experiment. This rigidity is undesirable in the following two scenarios that are often encountered in policy evaluation. First, when the true success rate of Policy A is significantly higher than that of Policy B, much fewer trials than N may suffice to establish that A>B. Nonetheless, all N trials must be conducted for each policy before the roboticist can perform the statistical analysis, leading to wasted time and hardware resources. In the second scenario, where Policy A and Policy B are closely matched, N trials may not provide sufficient statistical power to determine whether A>B or A<B. In such a case, the roboticist has to re-do the same experiment with the same or an increased N. Even worse, they have to discard the previously obtained evaluation results, as reusing them would compromise statistical validity. To address this need for a more rigorous analysis in the evaluation of imitation learning policies, a novel statistical tool that enables roboticists to compare two policies, for example, as shown in FIG. 3.

FIG. 3 is a diagram illustrating an example of a hardware implementation of a control policy evaluation system 300 for robotic imitation learning of the robot control policy, according to various aspects of the present disclosure. The control policy evaluation system 300 may be configured for evaluating control policies of a robot 350 based on imitation learning policies in response to images from video captured through a camera during operation of the robot 350. The control policy evaluation system 300 may be a component of a control policy evaluation server 370 utilizing a control policy database 380. For example, as shown in FIG. 3, the control policy evaluation system 300 is a component of the control policy evaluation server 370. Aspects of the present disclosure are not limited to the control policy evaluation system 300 being a component of the control policy evaluation server 370, as other devices, such as the robot 350, an autonomous vehicle, a bus, a motorcycle, or other like autonomous vehicles, are also contemplated for using the control policy evaluation system 300. The robot 350 may be autonomous or semi-autonomous.

The control policy evaluation system 300 includes a robotic policy control system 301 and the control policy evaluation server 370 in this aspect of the present disclosure. The robotic policy control system 301 may be a component of a robot 350. The robot 350 may be a cellular phone (e.g., a smart phone), a personal digital assistant (PDA), a wireless modem, a wireless communications device, a handheld device, a laptop computer, a cordless phone, a wireless local loop (WLL) station, a tablet, a camera, a gaming device, a netbook, a Smartbook, an Ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a global positioning system device, or any other suitable device that is configured to communicate via a wireless or wired medium.

The control policy evaluation server 370 may connect to the robot 350 for robot control policy evaluation of the robot. According to various aspects of the present disclosure, control policy evaluation server 370 enables a roboticist to collect rollout data from competing policies, one at a time, until a sufficient amount of statistical evidence is accumulated to conclude that one policy has a higher success rate than the other with a given confidence level. This approach extends to cases where we compare more than two policies on multiple tasks. The control policy evaluation server 370 provides a flexible policy evaluation framework that supports sequential statistical analysis as the roboticist performs additional trials. In the case where Policy A significantly outperforms Policy B, the conclusion A>B may be reached before they have to complete all the N trials. Conversely, when Policy A and Policy B are closely matched, the roboticist may have to inevitably perform more than N trials to establish either A>B or B<A. Nevertheless, the experiment can be stopped as soon as enough statistical evidence accumulates. Moreover, the sequential nature of the test allows the reuse of previously obtained evaluation results, ensuring that none of the precious experimental data is wasted.

The robotic policy control system 301 may be implemented with an interconnected architecture, such as a controller area network (CAN) bus, represented by an interconnect 308. The interconnect 308 may include any number of point-to-point interconnects, buses, and/or bridges depending on the specific application of the robotic policy control system 301 and the overall design constraints of the robot 350. The interconnect 308 links together various circuits, including one or more processors and/or hardware modules, represented by a camera module 302, a perception module 310, a processor 320, a computer-readable medium 322, a communication module 324, a locomotion module 326, a location module 328, a planner module 330, and a controller module 340. The interconnect 308 may also link various other circuits such as timing sources, peripherals, voltage regulators, and power management circuits, which are well known in the art, and therefore, will not be described any further.

The robotic policy control system 301 includes a transceiver 332 coupled to the camera module 302, the perception module 310, the processor 320, the computer-readable medium 322, the communication module 324, the locomotion module 326, the location module 328, a planner module 330, and the controller module 340. The transceiver 332 is coupled to an antenna 334. The transceiver 332 communicates with various other devices over a transmission medium. For example, the transceiver 332 may receive commands via transmissions from a user or a remote device. As discussed herein, the user may be in a location that is remote from the location of the robot 350. As another example, the transceiver 332 may transmit robotic state information from the perception module 310 to the control policy evaluation server 370.

The robotic policy control system 301 includes the processor 320 coupled to the computer-readable medium 322. The processor 320 performs processing, including the execution of software stored on the computer-readable medium 322 to provide sequential statistical testing functionality to evaluate imitation learning of control policies by the robot 350, according to the present disclosure. The software, when executed by the processor 320, causes the control policy evaluation system 300 to perform the various functions described for imitation learning with a surrounding environment from scenes in video captured by a camera of an autonomous agent, such as the robot 350, or any of the modules (e.g., 302, 310, 324, 326, 328, 330, and/or 340). The computer-readable medium 322 may also be used for storing data that is manipulated by the processor 320 when executing the software.

The camera module 302 may obtain images via different cameras, such as a first camera 304 and a second camera 306. The first camera 304 and the second camera 306 may be a vision sensor (e.g., a stereoscopic camera or a red-green-blue (RGB) camera) for capturing 2D RGB images. Alternatively, the camera module may be coupled to a ranging sensor, such as a light detection and ranging (LIDAR) sensor or a radio detection and ranging (RADAR) sensor. Of course, aspects of the present disclosure are not limited to the sensors, as other types of sensors (e.g., thermal, sonar, and/or lasers) are also contemplated for either of the first camera 304 or the second camera 306.

The images of the first camera 304 and/or the second camera 306 may be processed by the processor 320, the camera module 302, the perception module 310, the communication module 324, the locomotion module 326, the location module 328, and the controller module 340. In conjunction with the computer-readable medium 322, the images from the first camera 304 and/or the second camera 306 are processed to implement the functionality described herein. In one configuration, detected 2D object information captured by the first camera 304 and/or the second camera 306 may be transmitted via the transceiver 332. The first camera 304 and the second camera 306 may be coupled to the robot 350 or may be in communication with the robot 350.

The location module 328 may determine a location of the robot 350 using simultaneous localization and mapping (SLAM). Alternatively, the location module 328 may use a global positioning system (GPS) to determine the location of the robot 350. The location module 328 may implement a dedicated short-range communication (DSRC)-compliant GPS unit. A DSRC-compliant GPS unit includes hardware and software to make the robot 350 and/or the location module 328 compliant with one or more of the following DSRC standards, including any derivative or fork thereof: EN 12253:2004 Dedicated Short-Range Communication-Physical layer using microwave at 5.9 GHZ (review); EN 12795:2002 Dedicated Short-Range Communication (DSRC)-DSRC Data link layer: Medium Access and Logical Link Control (review); EN 12834:2002 Dedicated Short-Range Communication-Application layer (review); EN 13372:2004 Dedicated Short-Range Communication (DSRC)-DSRC profiles for RTTT applications (review); and EN ISO 14906:2004 Electronic Fee Collection-Application interface.

A DSRC-compliant GPS unit within the location module 328 is operable to provide GPS data describing the location of the robot 350 with space-level accuracy for accurately directing the robot 350 to a desired location. For example, the robot 350 is moving to a predetermined location and desires partial sensor data. Space-level accuracy means the location of the robot 350 is described by the GPS data sufficient to confirm a location of the robot 350 parking space. That is, the location of the robot 350 is accurately determined with space-level accuracy based on the GPS data from the robot 350.

The communication module 324 may facilitate communications via the transceiver 332. For example, the communication module 324 may be configured to provide communication capabilities via different wireless protocols, such as Wi-Fi, long term evolution (LTE), 3G, etc. The communication module 324 may also communicate with other components of the robot 350 that are not modules of the control policy evaluation system 300. The transceiver 332 may be a communications channel through a network access point 360. The communications channel may include DSRC, LTE, LTE-D2D, mmWave, Wi-Fi (infrastructure mode), Wi-Fi (ad-hoc mode), visible light communication, TV white space communication, satellite communication, full-duplex wireless communications, or any other wireless communications protocol such as those mentioned herein.

In some configurations, the network access point 360 includes Bluetooth® communication networks or a cellular communications network for sending and receiving data, including via short messaging service (SMS), multimedia messaging service (MMS), hypertext transfer protocol (HTTP), direct data connection, wireless application protocol (WAP), e-mail, DSRC, full-duplex wireless communications, mmWave, Wi-Fi (infrastructure mode), Wi-Fi (ad-hoc mode), visible light communication, TV white space communication, and satellite communication. The network access point 360 may also include a mobile data network that may include 3G, 4G, 5G, 6G, LTE, LTE-V2X, LTE-D2D, VoLTE, or any other mobile data network or combination of mobile data networks. Further, the network access point 360 may include one or more IEEE 802.11 wireless networks.

The control policy evaluation system 300 also includes the planner module 330 for planning a selected trajectory to perform a route/action (e.g., collision avoidance) of the robot 350 and the controller module 340 to control the locomotion of the robot 350. The controller module 340 may perform the selected action via the locomotion module 326 for autonomous operation of the robot 350 along, for example, a selected route. In one configuration, the planner module 330 and the controller module 340 may collectively override a user input when the user input is expected (e.g., predicted) to cause a collision according to an autonomous level of the robot 350. The modules may be software modules running in the processor 320, resident/stored in the computer-readable medium 322, and/or hardware modules coupled to the processor 320, or some combination thereof.

The National Highway Traffic Safety Administration (NHTSA) has defined different “levels” of autonomous agents (e.g., Level 0, Level 1, Level 2, Level 3, Level 4, and Level 5). For example, if an autonomous agent has a higher-level number than another autonomous agent (e.g., Level 3 is a higher-level number than Levels 2 or 1), then the autonomous agent with a higher-level number offers a greater combination and quantity of autonomous features relative to the agent with the lower-level number. These distinct levels of autonomous agents are described briefly below.

Level 0: In a Level 0 agent, the set of features installed in an agent provide no agent control but may issue warnings to the operator of the agent. An agent which is Level 0 is not an autonomous or semi-autonomous agent.

Level 1: In a Level 1 agent, the operator is ready to take operation control of the autonomous agent at any time.

Level 2: In a Level 2 agent, the operator is obliged to detect objects and events in the environment and respond if the set of features installed in the autonomous agent fail to respond properly (based on the operator's subjective judgement). In a Level 2 agent, the set of ADAS features installed in the autonomous agent can deactivate immediately upon takeover by the operator.

Level 3: In a Level 3 agent, within known, limited environments, the operator can safely turn their attention away from operation tasks but must still be prepared to take control of the autonomous agent when needed.

Level 4: In a Level 4 agent, the set of features installed in the autonomous agent can control the autonomous agent in all but a few environments, such as severe weather. The operator of the Level 4 agent enables the automated system only when it is safe to do so. When the automated Level 4 agent is enabled, operator attention is not required for the autonomous agent to operate safely and consistent within accepted norms.

Level 5: In a Level 5 agent, other than setting the destination and starting the system, no human intervention is involved. The automated system can reach any location where it is legal to operate and make its own decision (which may vary based on the district where the agent is located).

A highly autonomous agent (HAA) is an autonomous agent that is Level 3 or higher. Accordingly, in some configurations the robot 350 is one of the following: a Level 0 non-autonomous agent; a Level 1 autonomous agent; a Level 2 autonomous agent; a Level 3 autonomous agent; a Level 4 autonomous agent; a Level 5 autonomous agent; and an HAA.

The perception module 310 may be in communication with the camera module 302, the processor 320, the computer-readable medium 322, the communication module 324, the locomotion module 326, the location module 328, the planner module 330, the transceiver 332, and the controller module 340. In one configuration, the perception module 310 receives sensor data from the camera module 302. The camera module 302 may receive RGB video image data from the first camera 304 and the second camera 306. According to aspects of the present disclosure, the perception module 310 may receive RGB video image data directly from the first camera 304 or the second camera 306 as well as an RGB depth (RGB-D) to explore an environment from images captured by the first camera 304 and the second camera 306 of the robot 350. In various aspects of the present disclosure, the planner module 330 and/or the controller module 340 are configured for planning and control of the robot 350 to perform motion capture for teleoperation.

As shown in FIG. 3, the control policy evaluation server 370 includes a control policy evaluation module 372, a sequential testing module 374, a statistical data selection module 376, and a control policy evaluation module 378. The control policy evaluation module 372, the sequential testing module 374, the statistical data selection module 376, and the control policy evaluation module 378 may be components of a same or different artificial neural network, such as a convolutional neural network (CNN). The modules (e.g., 372, 374, 376, 378) of the control policy evaluation server 370 are not limited to a CNN. In operation, the perception module 310 receives a video stream from the first camera 304 and the second camera 306. The video stream may include a two-dimensional red-green-blue (2D RGB) left image from the first camera 304 and a 2D RGB right image from the second camera 306 to provide video frame images. The video stream may include multiple frames, such as image frames.

In some aspects of the present disclosure, the control policy evaluation server 370 is configured for evaluation of imitation learning performed by the robot 350 to operate according to a robot control policy. The control policy evaluation server 370 includes the control policy evaluation module 372 to select a first imitation learning robot control policy. Additionally, the control policy evaluation module 372 selects a second imitation learning robot control policy from multiple imitation learning robot control policies. According to various aspects of the present disclosure, the first imitation learning robot control policy and the second imitation learning robot control policy may be composed of hardware-based robot control policies or software-based robot control policies.

In this implementation, the control policy evaluation server 370 includes the sequential testing module 374 to perform sequential testing of the first imitation learning robot control policy and the second imitation learning robot control policy. Additionally, the control policy evaluation server 370 includes the statistical data selection module 376 to incrementally collect statistical evidence during the performing of the sequential testing. The control policy evaluation server 370 further includes the control policy evaluation module 378 to complete the sequential testing in response to the statistical evidence establishing a performance of the first imitation learning robot control policy being greater than a performance of the second imitation learning robot control policy or the performance of the second imitation learning robot control policy being less than the performance of the first imitation learning robot control policy. In this example, a novel policy may be identified as having a greater performance than a baseline policy. Alternatively, the control policy evaluation module 378 to concludes the sequential testing in response to insufficient statistical evidence for establishing a superior performance between the first imitation learning robot control policy and the second imitation learning robot control policy.

As shown in FIG. 3, the importance of trustworthy and efficient robot policy evaluation protocols has become paramount in imitation learning as the scale of underlying deep learning models and the complexity of tasks continue to increase. This is especially pronounced in dexterous manipulation where stochastic, contact-rich interactions between the robot 350 and the environment introduce inherent randomness in outcomes. One particularly important aspect of policy evaluation is policy comparison, where two policies are repeatedly deployed in an environment to assess their relative performance. Policy comparison forms the foundation of robot learning, enabling researchers to objectively measure the scientific progress of the field. Nevertheless, this setting introduces an additional source of stochasticity due to random outcomes of the second policy, making the reliability of the comparison more challenging to ensure.

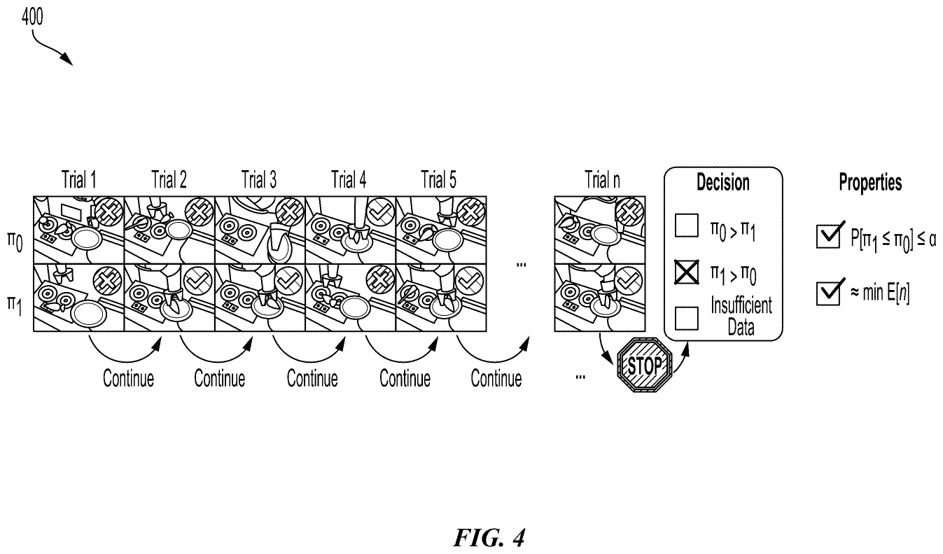

FIG. 4 is a diagram illustrating trial-based robotic control policy evaluation, according to various aspects of the present disclosure. In this example, FIG. 4 illustrates the robot policy comparison problem under binary success/failure metrics. For example, a novel policy π1 is compared against baseline policy π0 in a sequence of trials. Within a given evaluation budget, the evaluator seeks a statistically significant comparison in as few trials as possible to perform the evaluation. Due to the cost of hardware setup and calibration, as well as the limited inference speed of complex policies, these results generally arrive in sequence from a single (or few) hardware setups.

Considering the example policy comparison scenario presented in FIG. 4, the performance is quantified based on binary success/failure metrics, which is a common choice for policy evaluation, as continuous-valued rewards are often difficult to define. This scenario naturally arises when researchers want to demonstrate the effectiveness of a particular intervention (e.g., a new policy architecture) by comparing the new policy π1 against a baseline TO. Alternatively, π1 and π0 could represent the same policy evaluated under different environment distributions, providing insights on generalization. In either case, the evaluator faces two practical challenges.

First, only a small number of trials (e.g., 10-60) can be performed per evaluation setting due to the large human effort needed to reset the environment between trials and the substantial wall-clock time imposed by limited inference throughput of large policies. While high-fidelity simulators can alleviate the human effort and still provide valuable insights into policy performance, real-world evaluation remains indispensable for ensuring reliable deployment in downstream applications. Second, the evaluation results are revealed sequentially, possibly leading to fluctuating observations depending on when the evaluation is stopped.

Although conventional solutions propose statistical policy comparison approaches, these solutions follow the conventional batch testing scheme, requiring complete results from a pre-determined number of trials before the statistical test can be performed. Furthermore, the test can be conducted only once for the corresponding policy results; even if the test fails to determine the relative performance due to closely matched results, the evaluator cannot append more evaluation trials to the existing results to run the test again, as doing so would constitute p-hacking that invalidates statistical assurances. Unfortunately, this is a common but harmful research practice outside of robotics, which is preferable to be averted to ensure reproducible science.

To address these challenges, various aspects of the present disclosure are directed to allowing an evaluator to adaptively and near-optimally tailor the number of trials based on the data observed so far without compromising statistical assurances of the comparison. In the FIG. 4 example, the evaluator could observe more successes for policy π0 after conducting additional trials, even though policy π1 initially appeared superior after the first five. In one implementation, a novel sequential testing framework named STEP (Sequential Testing for Efficient Policy Comparison) is described for rigorously comparing performance of imitation learning policies.

Although described with reference to imitation learning, STEP is naturally applicable to evaluating any types of policies based on binary metrics, including reinforcement learning (RL) policies with sparse 0/1 reward. Unlike batch testing, our approach allows the number of trials to be varied within a given experimental budget. This critical feature offers two practical advantages. First, the evaluator can stop conducting trials early without sacrificing the probabilistic correctness of the comparison if enough statistical evidence is accumulated quickly in favor of π1 (or π0). Second, it reduces the epistemic risk of overconfident (and potentially incorrect) conclusions when π0 and π1 are closely matched, since the test will abstain from deciding if statistical evidence remains low after all the planned trials have been executed.

Alternatively, the evaluator may safely append additional trials to the original samples and re-conduct statistical analysis on all the results obtained thus far without inadvertent p-hacking. Various aspects of the present disclosure demonstrate these advantages through simulation and real-world robot manipulation experiments. Furthermore, extensive numerical experiments show that our STEP significantly outperforms state-of-the-art (SOTA) sequential methods, reducing the required number of trials by up to 32% without sacrificing probabilistic correctness. The specific contributions of this paper are as follows.

Various aspects of the present disclosure are directed to STEP policy evaluation, a novel sequential statistical frame-work for evaluating relative performance of two policies with tunable probabilistic correctness. In some implementations, a sequential testing approach admits an adaptive number of evaluation trials tailored to the difficulty of the underlying comparison while achieving near-minimal sample complexity. Additionally, extensions of our framework include (1) multi-task and (2) multi-policy comparison settings via a reduction to a set of pair-wise statistical comparisons.

### I. Preliminaries

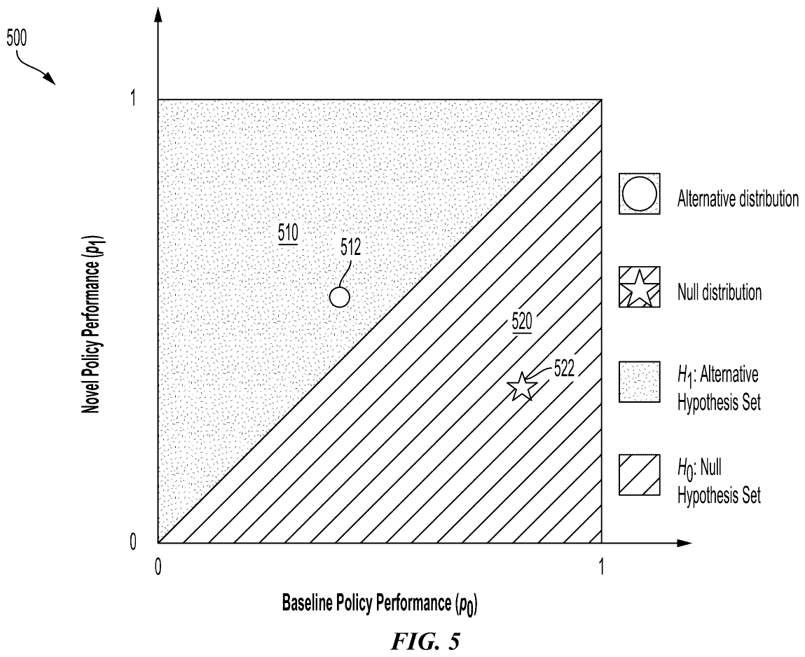

FIG. 5 illustrates a policy performance comparison graph 500 for robotic control policy evaluation between a novel policy and a baseline policy, according to various aspects of the present disclosure. In particular, FIG. 5 illustrates a policy comparison problem as a composite-vs-composite statistical test.

Consider a physical robot trained to complete a task in a variety of environment realizations. This setting is naturally modeled as a partially observable Markov decision process (POMDP), where the underlying state s represents the environment and robot states. The observation o is determined by the robot's embodiment and sensing apparatus. The training pipeline is designed to synthesize a policy taking actions a that achieve a high reward r(s, a)= [symbol] [s∈S_{success}] on a particular task, where S_{success} is a set of successful terminal states in which the episode will terminate. This reward encodes a binary success/failure criterion of the task. In imitation learning, a surrogate loss function is used to train a policy that matches the behavior of expert demonstrations instead of directly solving the POMDP. At the end of a training process, a policy π1 will be obtained. This policy has a true success rate (i.e., expected total episode reward) under a distribution [symbol] ₛ_{₀}_{,o}_{₀}, over the initial state and observation.

$${p}_{1} = {𝔼}_{{𝒟}_{{s}_{0} , {o}_{0} , {π}_{1}}} [ {\sum }_{t = 0}^{T} r ( {s}_{t} , {a}_{t} ) ] , \qquad ( 1 )$$

where dependence on the state transition and observation models are omitted for brevity. The true success rate is unknown and must be estimated via multiple evaluation trials.

Assumption 1 (Regularity): In each evaluation trial, the initial state so and the observation o₀ are drawn in an independent and identically distributed (i.i.d.) fashion from the underlying distribution [symbol] ₛ_{₀}_{,o}_{₀}. Note that this is a standard assumption in statistical testing. A disclosed method by which to approximately satisfy this condition in robotic evaluation assumes access to samples from [symbol] ₛ_{₀}_{,o}_{₀}, but does not assume [symbol] ₛ_{₀}_{,o}_{₀} itself to be known.

Under Assumption 1, the n^{th} evaluation trial involves making an i.i.d. draw of an environment from [symbol] ₛ_{₀}_{,o}_{₀}, and running the policy π1 in this environment. This yields a binary success/failure outcome z_{1,n} corresponding to an i.i.d. draw from a Bernoulli random variable with mean p₁, which is the true performance (success rate) of the policy π₁ on the task:

$${z}_{1 , n} ∼ Ber ( {p}_{1} ) . \qquad ( 2 )$$

Here, z_{1,n}=1 indicates success and z_{1,n}=0 failure. For any baseline policy π₀, the outcome of its n^{th} trial is denoted as z_{0,n}~Ber(p₀). For the sake of statistical analysis, the outcomes of two policies are paired by their indices in a vector zₙ=(z_{0,n}, z_{1,n}). The policy comparison problem can be formalized in the sense of Neyman-Pearson (N-P) statistical testing, where the null (skeptical) hypothesis is that the novel policy π₁ is no better than the baseline π₀ and the alternative is that the novel policy is indeed better:

$$Null Hypothesis {ℍ}_{0} : {p}_{1} \leq {p}_{0} ≡ ( {p}_{0} , {p}_{1} ) ∈ {ℋ}_{0} \qquad ( 3 )$$

$$Alternative Hypothesis {ℍ}_{1} : {p}_{1} > {p}_{0} ≡ ( {p}_{0} , {p}_{1} ) ∈ {ℋ}_{1} .$$

As shown in FIG. 5, a null hypothesis set 520 corresponds to a performance (p1) of a novel policy (π1) being worse (p₁≤p₀) than a performance (p₀) of a baseline policy (π0). Conversely, an alternative hypothesis set 510 corresponds to the performance of the novel policy p1 being better (p₁>p₀) than the performance of the baseline policy p₀. As described, the alternative hypothesis set 510 and the null hypothesis set 520 are each termed “composite” because they contain many elements. As shown in FIG. 5, for any pair of policies, the truth corresponds to a single point. For example, a first point 512 illustrates a case in which the alternative hypothesis set 510 is true (e.g., baseline success 45%, novel policy success 55%). Conversely, a second point 522 corresponds to the null hypothesis set 520 being true (e.g., baseline success 82%, novel policy success 35%).

As illustrated in FIG. 5, Equation (3) this amounts to a composite vs. composite statistical test. A hypothesis is termed “simple” if it is singleton, for example, corresponding to a single data-generating distribution. For example, (p₀,p₁)=(0.3,0.7) would be a simple hypothesis. If the hypothesis corresponds to multiple data-generating distributions, it is termed “composite.”

The Type-I error rate (denoted a) of a statistical test corresponds to the probability of falsely rejecting the null under the worst-case singleton element h₀ of the null hypothesis set [symbol] ₀—that is, under the hardest-to-distinguish (p₀, p₁)∈ [symbol] ₀. This type of error corresponds to falsely concluding that π₁ is better than π₀ when it is not. The power of a test (denoted 1-β) is the mixture probability of correctly rejecting the null when the alternative is true, under some measure on the set of alternatives. For example, a minimax measure mimics the Type-I setting (e.g., the worst-case singleton h₁∈ [symbol] ₁). However, due to the finite termination condition, such a measure is vacuous because there will always exist a (p₀, p₀+ϵ) for ϵ>0 sufficiently small such that the attainable power will only negligibly exceed random guessing. Therefore, in practice other measures are used. The Type-II error β is the associated (mixture) probability of failing to reject the null when the alternative is true. This represents failing to conclude that π₁ is better, when it is in fact better than π₀.

Finally, while the preceding development has focused on one-sided testing, the comparison problem naturally admits a bidirectional version allowing decisions for membership in either the alternative set (RejectNull) or the null set (AcceptNull). Note that the decision AcceptNull formally amounts to rejecting the null of a “flipped” version of Eq. (3). The subsequent discussion implicitly utilizes the bidirectional test, which will allow for the decision AcceptNull.

### II. Problem Formulation

Various aspects of the present disclosure assuming that a robot evaluator is tasked with distinguishing two policies via successive evaluations, resulting in the testing paradigm described in Section I. Additionally, it is also assumed that the evaluator has pre-selected the desired significance level α* of the comparison and a maximum number of trials (for each policy) that they are willing or able to run: Nₘₐₓ.

First, it is noted that the Type-I error must always be controlled in statistical testing, i.e., upper-bounded at the evaluator-specified rate α*∈(0,1). This represents a hard constraint (“validity”) that will be enforced in all subsequent testing procedures; a test is not feasible if it is not Type-I error controlling. The evaluator's goal is to synthesize a decision rule that limits the Type-I Error to α* while maximizing power and minimizing the expected number of evaluation trials.

A further assumption involves an underlying representation of the evaluation information collected thus far is available to the evaluator in a state xₙ=F(Z₁, Z₂, . . . , Zₙ). Then, the evaluator's procedure consists of deciding whether to Continue (gather another trial for each policy) or stop (and either AcceptNull or RejectNull). Given a decision set [symbol] ={AcceptNull, Continue, RejectNull}, the problem is to find a state partition ζ=u(x) to optimally balance minimizing the expected sample size and maintaining high power, conditioned on the Type-I Error rate constraint, as shown in Eq. (4):

$${min}_{ζ : 𝒳 ↦ 𝒰} {𝔼}_{μ ( {ℋ}_{1} )} [ {n}_{stop} + c {β}_{{N}_{max}} ] \qquad ( 4 )$$

$$s . t . {max}_{{h}_{0} = ( {p}_{0} , {p}_{1} ) ∈ {ℋ}_{0}} α ( ζ , {h}_{0} ) \leq {α}^{*}$$

$$0 \leq {n}_{stop} \leq {N}_{max} w . p \text{.1} .$$

This function is a multi-objective optimization which seeks to simultaneously minimize expected sample size and maximize power subject to the validity constraint. Informally, for any feasible terminal power

$$1 - {β}_{{N}_{max}}^{feasible}$$

(conditioned on Nₘₐₓ, α*, and the true underlying distribution, which is unknown a priori), there is a value of c>0 that effects a decision rule in Eq. (4) approximating a test controlling β=β_{feasible}. For example, this framework recovers the batch problem as c→∞ (demanding maximal power), and immediate termination as c→0⁺ (demanding minimal sample complexity). For the latter case: without looking at any data, draw a random number uniformly on [0,1]. If it is less than α* reject the null, otherwise fail to reject and terminate. This terminates at step 0 with probability 1, has power α*, and is valid. This objective will govern the methodology and analysis presented in the rest of the specification.

### III. Methodology

There are several important practical considerations to constructing a near-optimal solution to Eq. (4). The concrete challenges are first presented, and then the technical innovations that account for them are discussed. Various aspects of the present disclosure leverage significant mathematical structure in the testing problem; when insightful or intuitive, this will be explained in situ.

### A. State Representation

First, the information available is expressed to the evaluator at time n (i.e., after n evaluation trials have been performed for each policy) in a control-theoretic state representation; the evaluator's decision can then be understood as a state-feedback decision rule. In selecting this representation, the first instance of mathematical structure is the membership of Bernoulli distributions in the univariate exponential family; such distributions have known sufficient statistics which represent (informally) an optimal compression of the data for the purposes of testing and estimation. Thus, a natural (“near-minimal”) state representation is precisely the element-wise sufficient statistic for p₀ and p₁ respectively, augmented with a time state. For univariate exponential family distributions, the sufficient statistic is the sum of the observed data (e.g., respective number of successful trials under π₀ and π₁); this makes the state representation a first-order discrete integrator, etc., in Equation (5):

$${x}_{n + 1} = {x}_{n} + {d}_{n} \qquad ( 5 )$$

$${d}_{n} = ( {z}_{0 , n} , {z}_{1 , n} , 1 ) \sim ( Ber ( {p}_{0} ) , Ber ( {p}_{1} ) , 1 )$$

$${x}_{0} = {0}_{3} .$$

Unlike in a typical control problem, the state trajectory cannot be actively guided; instead, the decision to stop is based on the state trajectory. Concretely, the “control” involves partitioning the state space into stopping and continuation regions. In robotics, a similar set-theoretic notion arises in robust control and safe navigation, through the generation of invariant sets for dynamic systems (e.g., in reachability and barrier function-type methods), though those methods are primarily interested in non-stochastic uncertainty. Separately, many applications of asset pricing in mathematical finance utilize optimal stopping to set options prices under stochastic uncertainty.

### B. Decision Regions

In the sequential problem the state space partitions occur in sequence, yielding an effective representation of the decision rule ζ: [symbol] in the form of Eq. (6):

$$ζ ≡ {\{ {χ}_{n}^{Reject Null} , {χ}_{n}^{Accept Null} , {χ}_{n}^{Continue} \}}_{n = 1}^{{N}_{max}} . \qquad ( 6 )$$

At each time step, the sets jointly encode control decisions for every state. Intuitively, the larger the size of the rejection region

$${χ}_{n}^{Reject Null} ( resp . {χ}_{n}^{Accept Null} ) ,$$

smaller the number of expected trials needed to reject the null (resp. alternative), achieving a lower value of the stopping time component of Eq. (4). Focusing on

$${χ}_{n}^{Reject Null}$$

in the following development, an auxiliary objective is then to maximize the size of the set

$${χ}_{n}^{Reject Null}$$

globally across all n∈{1, . . . , Nₘₐₓ}. As discussed in Section I, the case of rejecting the alternative and accepting the null can be considered by flipping p₀ and p₁. A probabilistic approach is taken, allowing the states to reject with a probability less than 1.

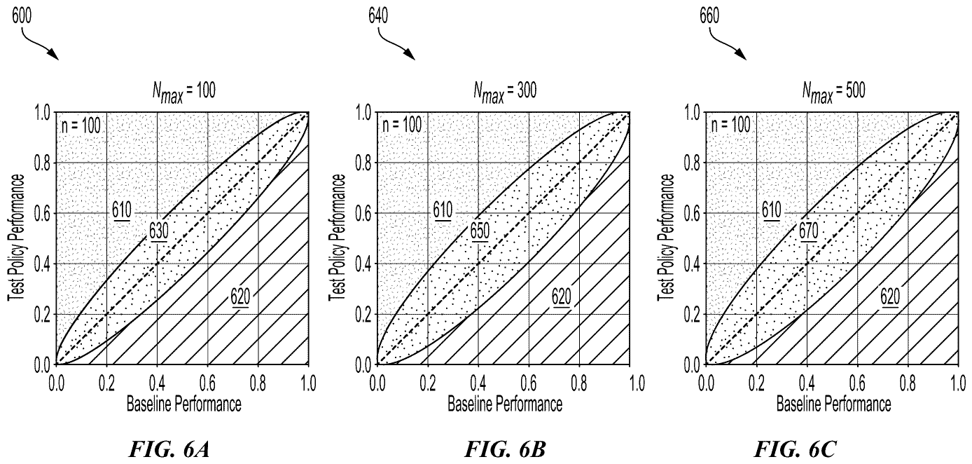

FIGS. 6A-6C further illustrates policy performance comparison graphs according to variations of an Nₘₐₓ value (e.g., a predetermined number of trials), according to various aspects of the present disclosure.

FIG. 6A illustrates a policy performance comparison graph 600, in which a null hypothesis set 620 corresponds to a performance (p1) of a novel policy (π1) being worse (p₁≤p₀) than a performance (p₀) of a baseline policy (π0). Conversely, an alternative hypothesis set 610 corresponds to the performance of the novel policy p1 being better (p₁>p₀) than the performance of the baseline policy p₀. Additionally, a continue region 630 is shown between the performance p0 and the performance p1. As shown in FIG. 6A, the policy performance comparison graph 600 is shown based on a first predetermined Nₘₐₓ value (e.g., Nₘₐₓ=100).

FIG. 6B illustrates a policy performance comparison graph 640, in which a continue region 650 is shown between the performance p0 of the baseline policy π0 and the performance p1 the novel policy π1. As shown in FIG. 6B, the policy performance comparison graph 640 is shown based on a second predetermined Nₘₐₓ value (e.g., Nₘₐₓ=300).

FIG. 6C illustrates a policy performance comparison graph 660, in which a continue region 670 is shown between the performance p0 of the baseline policy TO and the performance p1 the novel policy π1. As shown in FIG. 6C, the policy performance comparison graph 660 is shown based on a third predetermined Nₘₐₓ value (e.g., Nₘₐₓ=500). FIGS. 6A-6C show that the policy comparison graphs exhibit minimal sensitivity to the choice of Nₘₐₓ. As shown in Section III-E, this yields an efficient optimization problem. According to various aspects of the present disclosure, FIGS. 6A, 6B, 6C illustrate the state partition (e.g., 610, 620, 630, respectively) at n=100, under different settings of N_max=100, 300, and 500. This is distinguished from the (theoretical) null (e.g., 520) and alternative (e.g., 510) hypothesis sets depicted in FIG. 5.

In addition to the maximization, there are two core challenges to synthesizing such a partition. First, the Type-I Error rate must be controlled. The decision to stop and reject the null hypothesis in a state xₙ incurs risk due to the probability that xₙ was reached under data generated from some (p₀, p₁)∈ [symbol] ₀—i.e., under the null hypothesis in Eq. (3). Thus, having a large

$${χ}_{n}^{Reject Null}$$

risk violating Type-I Error rate control. Second, the temporal rate at which the risk is accrued must be set appropriately to encourage early stopping on easy instances (i.e., π₁ significantly outperforms π₀) without harming performance too much on harder instances (i.e., π₁ and π₀ are closely competing, which requires many trials to distinguish). The Type-I Error control is first addressed in Section III-C, and the temporal risk accumulation in Section III-D. The resulting tractable optimization problem is presented in Section III-E.

### C. Type-I Error Control

The composite nature of the null hypothesis (which contains all pairs [symbol] ₀={(p₀, p₁)∈[0,1]²|p₀≥p₁}) means that the decision-making problem can be thought of (informally) as analogous to distributionally robust control, where the uncertainty is over the particular worst-case (p₀, p₁)∈ [symbol] ₀. Controlling the Type-I Error in policy comparison then amounts to controlling the Type-I Error uniformly (robustly) for all h∈ [symbol] ₀. Suppose that some rejection region for the first t−1 steps has been obtained with accumulated risk αₙ₋₁, and this example is interested in bounding the Type-I Error for n by some αₙ>αₙ₋₁. Given the notion of stopping and continuation regions introduced in the previous section, this is expressed mathematically as:

$${max}_{h ∈ {ℋ}_{0}} {ℙ}_{h} ( {x}_{n} ∈ {χ}_{n}^{Reject Null} \vert {χ}_{n - 1}^{Reject Null} ) \leq {α}_{n} . \qquad ( 7 )$$

The dependence on the (probabilistic) rejection region for n−1 is made explicit in Eq. (7), reflecting the internal dynamic structure. For example, if some state Xₙ₋₁=(a, b, n−1) is rejected at n−1 with a non-zero probability, then the 1-step reachable states (e.g., (a+1, b, n)) under the dynamics of Eq. (5) are less likely to be feasible at n. The presence of many (infinite) elements h in the set of null hypotheses [symbol] ₀ makes verification of Type-I Error control challenging a priori, even for a single particular n. However, monotonicity, symmetry, and smoothness properties of this family of testing problems (noted in, for example, [13]) allow for efficient discretization procedures that preserve safety. Specifically, it suffices to consider a discrete set of the “worst-case” nulls [symbol] ₀={(p⁽¹⁾, p⁽¹⁾, (p⁽²⁾, p⁽²⁾), . . . , (p^{(M)}, p^{(M)})}, where 0≤p⁽¹⁾≤p^{(M)}≤1. Thus, Eq. (7) reduces to a finite set of individual inequality constraints. This set of constraints may by equivalently represented as a linear inequality Pₙwₙ≤αₙ [symbol] , where wₙ is a vector representing the probability of rejecting the null in each state xₙ∈ [symbol] ₙ={(0, 0, n), (0, 1, n), . . . (Nₘₐₓ, Nₘₐₓ, n)}. Pₙ is a non-negative matrix of size (M, | [symbol] ₙ|) where each row represents the probability of reaching particular states under h₍ᵢ₎=(p⁽ⁱ⁾, p⁽ⁱ⁾):

$${( {P}_{n} )}_{ij} = {ℙ}_{{h}^{( i )}} ( {x}_{n} = {x}_{n}^{j} \vert {χ}_{n - 1}^{Reject Null} ) , \qquad ( 8 )$$

where

$${x}_{n}^{j}$$

is the j^{th} (discrete) state in [symbol] ₙ. Given the rejection region from the previous time step n−1, the probability Eq. (8) is accurately computed by forward-propagating the previous state occupancy distribution (Pₙ₋₁)ᵢ according to the stochastic dynamics model Eq. (5) under h⁽ⁱ⁾.

### D. Power Adaptivity to Varying Difficulty: Risk Budgets

As discussed in Section III-B, the temporal rate of risk accumulation is appropriately adjusted. To formally define this notion of risk, a non-negative scalar function ƒ(n) for n∈{1, . . . , Nₘₐₓ} is introduced, which determines the maximum allowable Type-I Error under any null hypothesis at each step n. A constraint

$${\sum }_{n = 0}^{{N}_{max}} f ( n ) = {α}^{*}$$

is imposed to globally bound the Type-I error by α*. This risk “budget” can be interpreted as encoding the evaluator's competing objectives: to reject the null and stop the evaluation quickly in easier cases (front-loading the risk accumulation) against the desire the wait longer to achieve a significant decision in harder instances (delaying risk accumulation until more data is collected). Importantly, any risk budget ƒ that is nonnegative everywhere and sums to some r∈[0, α*] maintains Type-I error control at level α*. However, the shape of the risk budget will significantly influence the power of the resulting procedure, and thus represents an important component in solving (near-optimally) Eq. (4). With this said, in the following experiments the risk budget is fixed to be uniform in order to focus on optimizing the decision regions (described in Section III-E); to be explicit: this means the risk budget is

$$f ( n ) = \frac{{α}^{*}}{{N}_{max}}$$

for each scenario. This selection is heuristically reasonable but leaves potential for further improvements in future work.

### E. Tractable Optimization

Having specified the risk budget ƒ(n), it is straightforward to verify that the Type-I Error control is achieved if the following constraint is satisfied for all n∈{1, . . . , Nₘₐₓ}:

$${P}_{n} {w}_{n} \leq {\sum }_{k = 1}^{n} f ( k ) \text{?} . \qquad ( 9 )$$

Under this constraint, the objective is to maximize the size of the rejected region. The following proposal is provided to solve the following series of optimization problems to tractably construct the rejection regions, one for each n:

$${max}_{‖ {w}_{n} ‖ ∞ \leq 1} {\text{?}}^{T} {w}_{n}$$

$$s . t . {P}_{t} {w}_{n} \leq {\sum }_{k = 1}^{n} f ( k ) \text{?}$$

$$0 \leq {w}_{n} \leq 1 .$$

This objective encourages the rejection from as many states as possible, maximizing the size of

$${χ}_{n}^{Reject Null} .$$

Furthermore, it implicitly rejects from states less likely to occur under any null hypothesis, which are “cheaper” in terms of accruing risk. The first constraint ensures that the Type-I error is controlled up to time n, as discussed in Section III-C and Section III-D. The second constraint is to enforce boundedness of rejection probabilities in [0,1].

Algorithm 1 STEP Decision-Rule Synthesis

| Input: Nₘₐₓ > 0, risk budget function f(n), type-I error | |
|---|---|
| limit α* ∈ (0,1), number of approximation points M | |
| Initialize: ζ₀ = Ø, (P₀)ᵢⱼ = 1 if (i, j) = (0,0) else 0. | |
| for n ∈ {1, ... , Nₘₐₓ} do | |
| Pₙ ← Propagate(Pₙ₋₁, ζₙ₋₁, M) | {Eq. (8)} |
| wₙ ← Opt(Pn, f) | {Eq. (10)} |
| ζₙ ← Compress(wₙ) | |
| end for | |
| return ζ = ζ₁, ... , ζ_{N}_{ₘₐₓ} | {STEP policy} |

The optimization problem Eq. (10) is a simple linear program that can be efficiently solved by a standard optimization software; it is a maximization of ∥wₙ∥₁ over the nonnegative orthant, subject to additional linear inequality constraints to control Type-I Error. Because Pₙ depends on the rejection regions of n−1, the optimization needs to be performed sequentially for each n in increasing order. Nevertheless, all the computation can be performed offline prior to running the actual policy evaluation. See Algorithm 1 for the main algorithm. The fact that the optimization problems are sequentially solvable is owed to the isolation of the risk accumulation rate ƒ(n) as a tunable parameter; otherwise, the rejection regions would be generally coupled across n and the optimization would be more challenging.

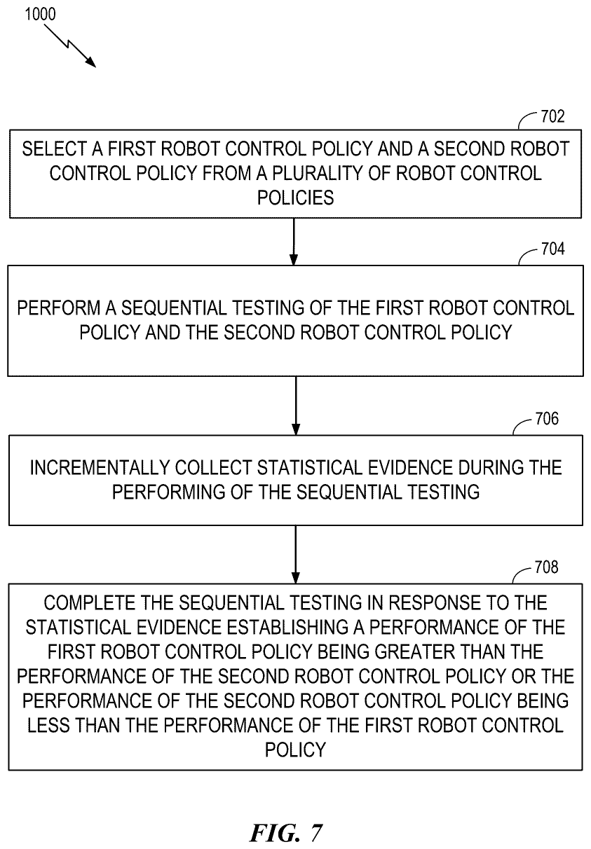

A process of control policy evaluation based on robotic imitation learning is illustrated, for example, in FIG. 7.

FIG. 7 is a flowchart illustrating a method 700 for an imitation learning robot control policy evaluation framework, according to aspects of the present disclosure. The method 700 begins at block 702, in which a first robot control policy and a second robot control policy are selected from a plurality of robot control policies. For example, as shown in FIG. 3, the control policy evaluation server 370 is configured for evaluation of imitation learning performed by the robot 350 to operate according to a robot control policy. The control policy evaluation server 370 includes the control policy evaluation module 372 to select a first imitation learning robot control policy. Additionally, the control policy evaluation module 372 selects a second imitation learning robot control policy from multiple imitation learning robot control policies. According to various aspects of the present disclosure, the first imitation learning robot control policy and the second imitation learning robot control policy may be composed of hardware-based robot control policies or software-based robot control policies.

At block 704, a sequential testing of the first robot control policy and the second robot control policy is performed. FIG. 4 example, the evaluator could observe more successes for policy π0 after conducting additional trials, even though policy π1 initially appeared superior after the first five. In one implementation, a novel sequential testing framework named STEP (Sequential Testing for Efficient Policy Comparison) is described for rigorously comparing performance of imitation learning policies.

At block 706, statistical evidence is incrementally collected during the performing of the sequential testing. For example, as shown in FIGS. 6A-6C show that the policy comparison graphs exhibit minimal sensitivity to the choice of Nₘₐₓ. As shown in Section III-E, this yields an efficient optimization problem. According to various aspects of the present disclosure, FIGS. 6A, 6B, 6C illustrate the state partition (e.g., 610, 620, 630, respectively) at n=100, under different settings of N_max=100, 300, and 500. This is distinguished from the (theoretical) null (e.g., 520) and alternative (e.g., 510) hypothesis sets depicted in FIG. 5.

At block 708, the sequential testing is completed in response to the statistical evidence establishing a performance of the first robot control policy being greater than the performance of the second robot control policy or the performance of the second robot control policy being less than the performance of the first robot control policy. For example, as shown in FIG. 3, the control policy evaluation server 370 further includes the control policy evaluation module 378 to complete the sequential testing in response to the statistical evidence establishing a higher performance either the first imitation learning robot control policy or a high performance of the second imitation learning robot control policy. In this example, a novel policy may be identified as having a greater performance than a baseline policy.

In some aspects of the present disclosure, the method 700 may be performed by the SOC 100 (FIG. 1) or the software architecture 200 (FIG. 2) of the robot 150 (FIG. 1). That is, each of the elements of method 700 may, for example, but without limitation, be performed by the SOC 100, the software architecture 200, or the processor (e.g., CPU 102) and/or other components included therein of the robot 150.

The various operations of methods described above may be performed by any suitable means capable of performing the corresponding functions. The means may include various hardware and/or software component(s) and/or module(s), including, but not limited to, a circuit, an application-specific integrated circuit (ASIC), or processor. Where there are operations illustrated in the figures, those operations may have corresponding counterpart means-plus-function components with similar numbering.

As used herein, the term “determining” encompasses a wide variety of actions. For example, “determining” may include calculating, computing, processing, deriving, investigating, looking up (e.g., looking up in a table, a database, or another data structure), ascertaining, and the like. Additionally, “determining” may include receiving (e.g., receiving information), accessing (e.g., accessing data in a memory), and the like. Furthermore, “determining” may include resolving, selecting, choosing, establishing, and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules, and circuits described in connection with the present disclosure may be implemented or performed with a processor configured according to the present disclosure, a digital signal processor (DSP), an ASIC, a field-programmable gate array signal (FPGA) or other programmable logic device (PLD), discrete gate or transistor logic, discrete hardware components, or any combination thereof designed to perform the functions described herein. The processor may be a microprocessor, but in the alternative, the processor may be any commercially available processor, controller, microcontroller, or state machine specially configured as described herein. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media may include random access memory (RAM), read-only memory (ROM), flash memory, erasable programmable read-only memory (EPROM), electrically erasable programmable read-only memory (EEPROM), registers, a hard disk, a removable disk, a CD-ROM, and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may connect a network adapter, among other things, to the processing system via the bus. The network adapter may implement signal processing functions. For certain aspects, a user interface (e.g., keypad, display, mouse, joystick, etc.) may also be connected to the bus. The bus may also link various other circuits, such as timing sources, peripherals, voltage regulators, power management circuits, and the like, which are well known in the art, and therefore, will not be described any further.

The processor may be responsible for managing the bus and processing, including the execution of software stored on the machine-readable media. Examples of processors that may be specially configured according to the present disclosure include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read-only memory (ROM), programmable read-only memory (PROM), erasable programmable read-only memory (EPROM), electrically erasable programmable read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such with cache and/or specialized register files. Although the various components discussed may be described as having a specific location, such as a local component, they may also be configured in numerous ways, such as certain components being configured as part of a distributed computing system.

The processing system may be configured with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described herein. As another alternative, the processing system may be implemented with an ASIC with the processor, the bus interface, the user interface, supporting circuitry, and at least a portion of the machine-readable media integrated into a single chip, or with one or more PGAs, PLDs, controllers, state machines, gated logic, discrete hardware components, or any other suitable circuitry, or any combination of circuits that can perform the various functions described throughout the present disclosure. Those skilled in the art will recognize how best to implement the described functionality for the processing system depending on the application and the overall design constraints imposed on the overall system.

The machine-readable media may comprise several software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a special purpose register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a non-transitory computer-readable medium. Computer-readable media include both computer storage media and communication media, including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc; where disks usually reproduce data magnetically, while discs reproduce data optically with lasers. Thus, in some aspects computer-readable media may comprise non-transitory computer-readable media (e.g., tangible media). In addition, for other aspects, computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a CD or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. A method for a robot control policy evaluation framework, the method comprising:
selecting a first robot control policy and a second robot control policy from a plurality of robot control policies;
performing a sequential testing of the first robot control policy and the second robot control policy;
incrementally collecting statistical evidence during the performing of the sequential testing; and
completing the sequential testing in response to the statistical evidence establishing a performance of the first robot control policy being greater than the performance of the second robot control policy or the performance of the second robot control policy being less than the performance of the first robot control policy.

2. The method of claim 1, in which the first robot control policy and the second robot control policy comprise hardware-based control policies.

3. The method of claim 1, in which the first robot control policy and the second robot control policy comprise software-based control policies.

4. The method of claim 1, in which completing the sequential testing occurs before a predetermined number of trials.

5. The method of claim 1, in which completing the sequential testing occurs if insufficient data is detected.

6. The method of claim 1, in which completing the sequential testing occurs when the performance of the first robot control policy is greater than the performance of a baseline policy.

7. The method of claim 1, in which incrementally collecting comprises:
pausing the performing of the sequential testing at an intermediate step less that a predetermined number of trials; and
deciding whether to continue testing according to intermediate date available at the intermediate step.

8. The method of claim 1, further comprising operating a robot according to one of the first robot control policy and the second robot control policy having a greater performance.

9. A non-transitory computer-readable medium having program code recorded thereon for a robot control policy evaluation framework, the program code being executed by a processor and comprising:
program code to select a first robot control policy and a second robot control policy from a plurality of robot control policies;
program code to perform a sequential testing of the first robot control policy and the second robot control policy;
program code to incrementally collect statistical evidence during the performing of the sequential testing; and
program code to complete the sequential testing in response to the statistical evidence establishing a performance of the first robot control policy being greater than the performance of the second robot control policy or the performance of the second robot control policy being less than the performance of the first robot control policy.

10. The non-transitory computer-readable medium of claim 9, in which the first robot control policy and the second robot control policy comprise hardware-based control policies.

11. The non-transitory computer-readable medium of claim 9, in which the first robot control policy and the second robot control policy comprise software-based control policies.

12. The non-transitory computer-readable medium of claim 9, in which the program code to complete the sequential testing occurs before a predetermined number of trials.

13. The non-transitory computer-readable medium of claim 9, in which the program code to complete the sequential testing occurs if insufficient data is detected.

14. The non-transitory computer-readable medium of claim 9, in which the program code to complete the sequential testing occurs when the performance of the first robot control policy is greater than the performance of a baseline policy.

15. The non-transitory computer-readable medium of claim 9, in which the program code to incrementally collect comprises:
program code to pause the performing of the sequential testing at an intermediate step less that a predetermined number of trials; and
program code to decide whether to continue testing according to intermediate date available at the intermediate step.

16. The non-transitory computer-readable medium of claim 9, further comprising program code to operate a robot according to one of the first robot control policy and the second robot control policy having a greater performance.

17. A system for a robot control policy evaluation framework, the system comprising:
a robot; and
a control policy evaluation server, comprising:
a control policy selection module to select a first robot control policy and a second robot control policy from a plurality of robot control policies to control the robot;
a sequential testing module to perform a sequential testing of the first robot control policy and the second robot control policy;
a statistical data selection to incrementally collect statistical evidence during the performing of the sequential testing; and
a control policy evaluation module to complete the sequential testing in response to the statistical evidence establishing a performance of the first robot control policy being greater than the performance of the second robot control policy or the performance of the second robot control policy being less than the performance of the first robot control policy.

18. The system of claim 17, in which the first robot control policy and the second robot control policy comprise hardware-based control policies.

19. The system of claim 17, in which the first robot control policy and the second robot control policy comprise software-based control policies.

20. The system of claim 17, in which the robot is to operate according to one of the first robot control policy and the second robot control policy having a greater performance.
